(19) United States
(12) Patent Application Publication
(10) Pub. No.: US 2025/0371815 A1
(43) Pub. Date: Dec. 4, 2025

(54) METHODS AND SYSTEMS FOR GENERATING IMMERSIVE, CONGRUOUS CONTENT FOR ASYNCHRONOUS EXPERIENCE SHARING

(71) Applicant: Adeia Imaging LLC, San Jose, CA (US)

(72) Inventors: Jean-Yves Couleaud, Mission Viejo, CA (US); Ning Xu, Irvine, CA (US)

(21) Appl. No.: 18/679,842

(22) Filed: May 31, 2024

(51) Int. Cl. G06T 19/00; G06V 10/24; G06V 10/44

(52) U.S. Cl. CPC G06T 19/006; G06V 10/245; G06V 10/44; G06V 2201/07

(57) ABSTRACT

Systems and methods are described for enabling asynchronous experience sharing between users visiting the same environment at two different times. First image data is received, captured during a first time period, wherein the first image data comprises data characterizing the environment in three dimensions. Stored second image data is accessed, the stored second image data captured during a second time period earlier than the first time period, the stored second image data characterizing the environment in three dimensions. A display image is caused to be rendered at a user device during the first time period based on the first image data, the display image comprising an object from the second image data.

### BACKGROUND

The present disclosure relates to methods and systems for sharing media content of an experience at an environment. More particularly, but not exclusively, the present disclosure relates to capturing an experience of the environment on a user device during a period, and generating the experience for display on a user device at a later time period.

### SUMMARY

Experience sharing between users is made possible, for instance, by way of capturing images using an imaging device and sharing these images, either directly between user devices, or indirectly by way of engagement with a web host, such as by way of a social media post. These forms of image sharing permit users to view the prior experiences of other users regardless of their current location.

In many situations it may be desired for a user to view and engage with a prior experience or event as if the user was at the same location as and at the same time of the prior experience. Extended reality (XR) technology, such as augmented reality (AR), virtual reality (VR), mixed reality (MR) and spatial computing, provides a user with a heightened level of immersion, delivering an illusion that an event that occurred at some location and time may be occurring presently at the user's location. Such shared experiences may take the form of generated and shared two-dimensional media which is adapted for display to the user stereoscopically, by generating a two-dimensional display image per eye of the user, giving the user the illusion of depth. These experiences can include the placement of a virtual screen in front of the user for engagement at the user's location, or may include the placement of virtual objects in the environment of the user for visualizing or engagement. It is also possible in some cases to geographically anchor content, such as virtual signage or animated content, to be experienced by users visiting a specific location.

Environments can, however, be subject to change in various ways. This can mean that content captured at a particular time within an environment, for experiencing by a viewer at a later time, can appear to be incongruous with the updated environment when viewed at the later time. Since this can have the effect of hindering long-term suitability of such content, current implementations can have limited suitability for their intended purpose. It is therefore desirable to improve the temporal relevance and effective lifetime of immersive content for asynchronous experience sharing among viewers.

Systems and methods are provided herein for improving the quality of an asynchronous event-viewing experience (for example an extended reality viewing experience), and improving the temporal relevance and effective lifetime of such a viewing experience. In particular, systems and methods herein may permit one or more users of an extended reality device to experience an occurrence or an event having taken place in a particular environment at an earlier time to that at which the one or more users are present within the environment. The earlier occurrence or event may have been captured within the environment using earlier-captured and stored data characterizing the environment at the earlier time. In particular, the earlier-captured and stored data may characterize the environment in three dimensions, for example by including a depth, or z-axis, component. Any suitable environment mapping technology will be appreciated and can include, for example and without limitation, time-of-flight modalities. Examples of such data may include, without limitation, point cloud data or mesh data. Additional examples may include a two-dimensional array of image pixel data, the pixel data having associated therewith any additional data providing depth information relating to the environment. Such data extends two-dimensional image data in characterizing an environment due to the added depth, or z-axis, context provided by the data. Depth, or z-axis, context can offer a number of benefits when providing an immersive viewing experience, where these benefits may be linked to an improved understanding of positioning of components within the environment, and a perspective of the image source. This positioning and perspective information can allow a recreation of the environment from more than one perspective, for example if an event or occurrence is to be displayed at a user device at the later time from a different position in the environment, or having a different perspective of the event or occurrence. While it is possible to infer depth context from two-dimensional image data in conjunction with, for example, a machine learning process, such two-dimensional image data is not itself inherently three-dimensional. Such an inference can provide additional computational overhead on a system, which may in some cases be constrained to performing such processing in real-time.

At the later time, it may be determined that a viewer (which may be the same viewer or a different viewer to that which viewed the event or occurrence at the earlier time) is located within the environment. The systems and methods provided herein therefore comprise accessing the earlier captured and stored data. The systems and methods provided herein additionally comprise a live capturing of data characterizing the environment in three dimensions at the later time. When the earlier captured and stored data is accessed for the purpose of presenting at a user device the event or occurrence which occurred at the earlier time, the availability of the live capture of data characterizing the environment in three-dimensions at the later time provides updated environmental information, which can aid in the reconstruction of the event or occurrence at a user device at the later time. The three-dimensional nature of the live-captured data and the earlier captured and stored data can permit improved accuracy and precision in locating and positioning the event or occurrence in the environment for displaying at a user device at the later time. In providing live three-dimensional context for positioning the event or occurrence in the environment for displaying at a user device at the later time, the present disclosure can help to reduce the computational resources required, at a user device and/or at one or more remote servers, in accurately and precisely recreating the event or occurrence for displaying at a user device at the later time. In some cases the viewer or user device may move position, or may be moving, during the recreation, thereby requiring a real-time update of the recreation of the event or occurrence in the environment in accordance with an updated perspective of the user device. Using the three-dimensional characterization of the environment in the earlier captured and stored data, and the live captured data, may help to reduce latency in any said real-time adjustment required in the display at the user device. The event or occurrence present within the earlier captured and stored data may be represented by an object determined from the earlier captured and stored data. The object may be rendered at an extended reality device for display at a user device at the later time, for example and without limitation, on a transparent display modality (such as a transparent display panel) of an augmented reality-enabled device, or as part of a video recreation of the environment on a display panel of a mixed reality-enabled device or a virtual reality-enabled device.

In some cases, the environment of the later time may have changed when compared with the earlier time, for example to comprise a different arrangement of components. In some cases, the live-captured data and the earlier captured and stored data may each be captured by different capture methods or devices. Characterizing the environment in three-dimensions in the live-captured data and in the earlier captured and stored data may improve accuracy and precision in locating specific environmental components in order to correctly locate and position the event or occurrence for the purpose of reproduction at the later time.

In some cases, an event or occurrence taking place in an environment at the later time may be captured as part of the live captured data. The earlier captured and stored data may, in such cases, be accessed and modified to include the event or occurrence of the live captured data. The modified earlier captured and stored data may further be stored, either as an updated version of the earlier captured and stored data or as a separately stored image or video data.

According to systems and methods described herein, first image data of an environment is received, the first image data captured during a first time period and comprising data characterizing the environment using one or more of: depth information; two-dimensional image data; or data characterizing the environment in three dimensions. For example, the first image data may be received at or via a server from a user device, or at a processor of the user device. Generally, data characterizing the environment in three-dimensions may refer to the three spatial dimensions, and includes any data defining or including a depth or volumetric component of the environment, for example point cloud data, mesh data, or depth data in addition to two-dimensional image data. It will be appreciated that the term image data as used herein may be any suitable media content data including image or video data and may in some examples comprise audio data or may be associated with accompanying audio data.

Stored second image data of the environment, captured during a second time period earlier than the first time period, may be accessed, the second image data comprising data characterizing the environment in three dimensions during the second time period. The stored second image data may, for example, be stored at, and/or accessed from, any suitable memory, such as for example server memory or local memory of a user device. The stored second image data may be of the same type or different to the first image data. A display image may be caused to be rendered at a user device (for example an extended reality device) during the first time period, the rendering based on the first image data. The display image may for example be a two-dimensional display image or a three-dimensional display image. In examples wherein the display image is a two-dimensional display image, the display image may depict a planar view of the environment, or an object to be displayed within the environment, as viewed from a perspective of a user or a perspective of a user device. Generally, three-dimensional display image will be understood to mean any image having a depth or volumetric component, for example using voxels, and may include three-dimensional video data, such as spatial video. The display image may comprise an object from the stored second image data. An object of the stored second image data may therefore be identified for display at a user device during the first time period, the object identified from the second stored image data, and which may or may not also be identified in the first image data.

In some examples, accessing the stored second image data may comprise selecting the stored second image data from a plurality of the stored second image data. In such examples, the environment may be a popular tourist attraction captured frequently by users and stored as second stored image data. The plurality of the stored second image data may comprise, or have captured, a popular event which was captured and stored many times. The event may be a long-lasting event which was captured at various discrete or overlapping second time periods, and may have been captured from various perspectives. There may therefore be a plurality of stored second image data associated with the environment, from which to select as part of accessing the stored second image data in systems and methods disclosed herein.

Selecting the stored second image data may, for example, be based on one or more selected from: an interaction indicator of the second image data; a number of views of the second image data; the second time period of the second image data; a determined similarity between the second image data and the first image data; an association between a user device used in capturing the stored second image data and a user device used in capturing the first image data. Any suitable technique for selecting the stored second image data from a plurality of the stored second image data will be appreciated. In examples wherein the second image data is selected based on an interaction indicator of the second image data, the interaction indicator may be any suitable indication of one or more user interactions with the second image data, and may indicate for example, one or more of: a total number of views or times selected; a number of views or times selected over a time period (such as the last hour, the last day, the last week or the last month); a number of positive interactions, such as a number of likes; a number of associated comments; a number of times shared. It may be the case in some examples therefore that the second image data is selected at least in part based on the most positive interactions, comments or a determined popularity. Such information may act to reduce or screen the number of second image data in the plurality of second image data from which the second image data is to be selected. In examples wherein the second image data is selected based on the second time period, the second time period may be the most similar time period to the first time period, for example, at the most similar time of day, during a similar season, or at a scheduled time of a periodic or repeating event.

In such examples, there may be a reduced amount of image processing required in the displaying of the object in the environment, particularly in examples wherein the object of the second image data is modified based on the first image data prior to rendering as part of the display image. In examples wherein the second image data is selected based on a determined similarity between the second image data and the first image data, the similarity may be any determined similarity, the similarity allocated to the second image data in some examples by way of a similarity score. In such examples, each second image data of the plurality of second image data may be allocated a similarity score and ranked based on the corresponding similarity score. The similarity may comprise any suitable similarity, such as a similarity of perspective from which the second image data was captured compared with a perspective from which the first image data is captured, or a similarity between features extracted from the first image data and the second image data. The similarity may lead to a more accurate reproduction of the object for rendering in the environment at the first time period, and may in some cases reduce the amount of image processing which may be required ahead of rendering the object for viewing in the environment.

In examples wherein the second image data is selected based on an association between a user device used in capturing the stored second image data and a user device used in capturing the first image data, the association may, for example, be a proximity of the respective users in a social network. For example, only second image data captured by user devices of users associated with the user of a user device capturing the first image data may be selected, such as second image data captured by user devices of friends of the user of the user device capturing the first image data.

Selecting the stored second image data from a plurality of the stored second image data may, in some examples, comprise selecting more than one second image data. In such examples, the selected stored second image data may comprise a composite of the more than one second image data. By way of example, a user device is present in an environment during a first time period, and associated with the environment are a plurality of stored second image data from which to obtain an object to be rendered as part of a display image at the user device. Of the plurality of stored second image data, two stored second image data depict an event occurring at a second time period: one from a front-view perspective, and another from a rear-view perspective. The user device may be positioned within the environment in front of the location where the event took place, such that the second image data of the front-view perspective is selected for accessing. As the user device is moved within the environment, the movement may take the user device toward the rear of the location where the event took place. The second image data of the rear-view perspective may then, based on a detection of the movement, be selected for accessing.

A dynamic selection of appropriate stored second data may therefore be performed, for example based on a movement, position, orientation or perspective of the user device in the environment, and in some examples, systems and methods may select any suitable number of stored second image data for accessing at any suitable point during the first time period. The selecting and accessing may, in some examples, be determined based on a detected omission of a selected stored second image data, for example, if a portion of the object is missing, incomplete or of inferior image quality in an accessed stored second image data, when compared with one or more other of the stored second image data. The stored second image data may therefore be selected and accessed in order to improve or complete at least a portion of the object from a different stored second image data. Following the example above, as the user device moves from the front to the rear of the event, the initially selected and accessed front view perspective may comprise a missing rear view perspective, or an incomplete or inferior quality predicted rear-view perspective. It may be determined that the second image data of the rear-view perspective provides a more complete or higher quality rear perspective view of the event than the currently accessed front-view perspective second image data. The rear-view perspective second image data may therefore be selected for accessing, such that for example a dynamic and seamless transition from the front-view perspective to the rear-view perspective of the object is provided for rendering at a display of the user device. In such a way, information contained within multiple stored second image data may be used as a reservoir from which appropriate image data may be selected for accessing at an appropriate point during the first time period, to provide a most complete or highest quality recreation of the object or event during the first time period, for example such that the object or event may be experienced from any angle, orientation or perspective within the environment throughout the first time period.

In the context of the present disclosure it will be understood that “the environment” of the first image data and the second image data is the same or similar environment, e.g., based on a location. The environment in the first image data may be captured from a first perspective and the environment in the second image data may be captured from a second perspective. It will be appreciated the first perspective and the second perspective may be the same or different. Three-dimensional characterization of the environment in at least the second image data, and preferably also in the first image data, helps to produce accurate rendering of the object in the environment during the first time period irrespective of the perspective of the first image data being captured.

The term “environment” will be understood to mean any space viewed by a user and captured by a user device in the form of the first and second image data. The environment may be any suitable environment, and may in some non-limiting examples be a village town or city; a landmark; a building such as a stadium, a museum or an art gallery; an amusement park or a theme park. In some examples, it may be determined that the environment characterized by the first image data and the environment characterized by the second image data are the same. In some such examples, the accessing of the stored second image data may be based on the determination. It will be appreciated that determining that the environment characterized by the first image data and the environment characterized by the second image data are the same may be performed by any suitable method. In some examples, the stored second image data may comprise a geolocation tag or any suitable association with a physical location, such as in the form of metadata stored alongside or associated with the stored second image data. In some examples, a user device, such as an extended reality device, comprises a location sensor, such as a GPS sensor, the determination may comprise comparing a location of the user device with the location associated with the stored second image data, and determining that the respective locations are the same, or within a threshold proximity of one another. The threshold proximity may be a distance from which the object from the stored second image data is visible.

In the context of the present disclosure, the first image data may be captured by a first user device, e.g., associated with a first user, and the second image data may be captured by a second user device associated with a second user. It will be appreciated that the first user device and the second user device may be the same device or different devices, and that the first and second users may be the same user or different users. For example, the terms “first” and “second,” in this context, may relate to a timing of the capturing of the first and second image data.

In some examples, the object is disposed at a position in the environment in the stored second image data, wherein the rendering comprises rendering the object at the position in the environment. The rendering of the object at the position in the environment may comprise aligning the position in the stored second image data with a corresponding position in the first image data. The position in the environment may be determined at least in part by a depth component of the stored second image data, and the corresponding position in the first image data may be determined at least in part by a depth component of the first image data. In some examples, the position in the environment may be determined using each dimensional component of the stored second image data characterizing the environment in three dimensions, and the corresponding position in the first image data may be determined using each dimensional component of the stored second image data characterizing the environment in three dimensions. Making use of all three-dimensional components across both the first and second image data may provide more accurate rendering of the object for viewing at the correct position in the environment.

In some examples, the object is modified based on the first image data. The terms “the object is modified” and “modifying the object” will be understood to mean modifying, by any suitable implementation, data representing the object such that the object is rendered differently at the first time period to how it was captured in the stored second image data. The data representing the object may characterize one or more selected from: lighting; shadow; color; texture; reflectance; diffraction; luminance; chromaticity; contrast; brightness; transparency; opacity; scale; rotation; orientation; pose; position; transform; resolution; frame rate; frame density; dynamic range; color gamut. In some examples, during the first time period, a perspective from which the first image data is captured may be different to a perspective from which the stored second image data was captured. A resulting impact on positioning, rotation, orientation, pose and scale of the object may therefore be represented in the rendering during the first time period. Additionally, or alternatively, aspects of the environment may have changed compared with the environment during the second time period. For example, the environment may, during the first time period comprise a different arrangement of components as those of the environment characterized by the stored second image data. Such components may in some cases affect how the object is to be displayed at a user device during the first time period, and may therefore cause the object to be rendered temporarily or permanently, partially or wholly obstructed or occluded by one or more environment components. In such examples, there may be a resulting impact on a transparency or an opacity of part or all of the object which may therefore be represented in the rendering during the first time period. The environment may, in some cases, be subject to different weather or lighting conditions during the first time period to those of the second time period (for example a different time of the day or a different season) which may affect components of the environment differently at the first time period when compared to the environment during the earlier second time period. A resulting impact on, for example, lighting, shadow, or a surface quality of the object such as texture, reflectance, luminance, chromaticity, contrast, or brightness may therefore be represented in the rendering during the first time period.

The first image data may be captured using a different capture method or using a different device type or device generation to that of the stored second image data. Any resulting impact on, for example, resolution or frame rate of the capture technology may therefore be represented in the rendering during the first time period, which may for example include up-or down-scaling, increase or decrease in frame rate or frame density, or increase or decrease in dynamic range or color gamut, thereby improving visual quality in some cases while accounting for any reduced processing capability or display technology capability in others. In some examples, the object may, in the stored second image data, be captured such that at least a portion of the object is occluded, whether by the presence of a foreground occlusion or due to a field of view, a perspective or a device orientation from which the stored second image data was captured. In such examples, the stored second image data may not comprise the whole object to be rendered from a viewpoint or perspective of the first image data. As such, modifying the object for rendering at the first time period may comprise predicting the missing or occluded portion of the object for reconstructing the missing or occluded portion during the rendering of the object, which may include a prediction of a different view or perspective of the object from that captured in the second image data, such as a view or perspective of the first image data. In such cases, the prediction may comprise any suitable prediction technique such as interpolation or in-painting, which may comprise use of a trained machine learning model.

In some examples, a first plurality of features may be extracted from the first image data. Feature extraction may be performed on the first image data for example for the purpose of comparison with corresponding features of the stored second image data. The term “feature extraction” will be understood to include any suitable extraction of information within the image data used to represent characteristics of, or regions of interest within, the image data, and may include any suitable data or dimensionality reduction process. Extracted features may, for example and without limitation, include one or more selected from: edges; point features; corners; blobs; regions of interest; brightness; color; texture; motion; scale invariant features; rotation invariant features; depth features; surface normals; curvature; volume; shape; topology; geometrical features; semantic context. It will be appreciated that any suitable two-dimensional or three-dimensional features may be extracted which permit further processing of the first image data, such as for comparison with the stored second image data. In examples wherein the first image data characterizes the environment in three-dimensions, extraction of three-dimensional features may provide an improved understanding of the environment using features such as surface normals; curvature such as principal curvature, Gaussian curvature and mean curvature; volume and shape features including spherical harmonics and shape histograms; three-dimensional texture information and topological features; depth maps; three dimensional point features; edge direction frequencies using for example oriented gradient histograms; and three-dimensional geometrical information such as using centroid and bounding boxes.

The features may in some examples be learned features which are learned from a training dataset of a machine learning model. The features may in some examples be extracted as part of a semantic segmentation process and may therefore represent, or inform, a semantic context allocated to a portion of the first image data. The allocation of a semantic context to a portion of the first image data in accordance with the extracted features may in some examples be performed using a trained machine learning model. The first plurality of features may be compared with a second plurality of features extracted from the stored second image data. The accessing of the stored second image data may therefore comprise: accessing the second plurality of features. The second plurality of features may therefore be associated with the stored second image data, for example as metadata thereof, or may be stored alongside the stored second image data.

Prior extraction and storage of the second plurality of features, whether on a user device or at a remote server, for accessing during the first time period may reduce latency in the rendering of the display image at the user device during the first time period. In other examples the accessing of the stored second image data may further comprise extracting the second plurality of features from the second stored image data and optionally storing the second plurality of features. The comparison of the first plurality of features with the second plurality of features may be to identify one or more matched features of the first image data and the stored second image data. The comparison may additionally, or instead, be to identify one or more unmatched features of the stored second image data. The rendering may be based on one or more selected from: the identified one or more matched features; or the identified one or more unmatched features. Matched features across the first image data and the stored second image data may aid in reducing the computational resources required in aligning the second image data with the first image data for rendering the display image, and may thereby reduce latency. Feature matching may also indicate which portion or portions of the stored second image data may be discounted for the purposes of rendering the object in the display image, and may therefore conserve computation where possible and reduce latency.

In some examples, the stored second image data may be spatially aligned with the first image data, for example using the one or more matched features. The spatial alignment may include, be aided by, or be performed in addition to, pose estimation. Spatial alignment between the first image data and the stored second image data can aid in increasing positional accuracy when rendering the display image comprising the object during the first time period. The spatial alignment can be supported by the characterization of the environment in three dimensions by the first and second image data, and/or by the plurality of matched features, and may thereby permit spatial alignment of the first and second image data even when the first and second image data are captured from different perspectives.

The object may be identified from the stored second image data based on a saliency evaluation. The term “saliency evaluation” will be understood to mean any suitable method of identifying within, or isolating from, the stored second image data one or more objects, regions or features of interest. The evaluation may be performed using one or more selected from: one or more portions of the second image data; the second plurality of features; the identified one or more unmatched features. The saliency evaluation may, in some examples, be performed using any suitable deep learning approaches such as, for example, convolutional neural networks and generative adversarial networks, and any deep learning model used may learn saliency cues from a training dataset for use in The saliency evaluation.

Use of the one or more unmatched features as part of the saliency evaluation may require a saliency evaluation of features already determined to be uniquely present in the stored second image data, or may direct to or provide, local or global context for a downstream saliency evaluation. The unmatched feature identification may therefore represent a first data reduction step prior to a saliency evaluation, thereby reducing the computational resources required for the downstream saliency evaluation. The one or more objects, regions or features of interest may comprise the object. It will be understood that the saliency evaluation may be any suitable saliency evaluation technique, and may comprise any combination of bottom-up or top-down saliency evaluation techniques. By way of example, in a bottom-up saliency evaluation technique the one or more objects, regions or features of interest may be identified based on any suitable features of the stored second image data such as color; intensity; texture; orientation; motion; size; spatial location; depth. By way of further example, in a top-down saliency evaluation technique the one or more objects, regions or features of interest may be identified based on any suitable factors, for example external factors, relating to the second image data, which may in some examples include data or metadata associated with the second image data.

The factors may include, or be associated with, a semantic context associated with the stored second image data, the semantic context being identified within the data or metadata associated with the stored second image data. For example, features, regions or objects of interest may be identified that, in accordance with the semantic context, are determined to be meaningful or important to the context of the image, and thereby have a higher likelihood of being determined to be salient by the saliency evaluation. For example, the stored second image data may be associated with a caption or a comment comprising any suitable text, image, emoticon, emoji, and audio data, the caption or comment input by a user relating to the stored second image data. The stored second image data may comprise or be associated with corresponding audio data comprising speech. In some examples, when any part of the audio data is detected or transcribed using any suitable natural language processing method, the audio data may be identified as comprising such a sematic context. Such identified speech may be combined with other suitable data from the stored second image data to interpret a context of the image data. For example, within the stored second image data a pose or a gesture of a person pointing to a particular object in the environment, while corresponding audio data indicates the person is simultaneously exclaiming “check that out” or “look at that”, may be used in the saliency evaluation. In other examples, the stored second image data may be posted or published as part of a webpage comprising semantic context, for example in the form of an article. In further examples, the stored second image data may be posted or published in association with a social network profile comprising contextual information, such as identification and activity information, relating to the profile owner and other social network users, such as users within a threshold proximity to the profile owner within the social network. The semantic context may, as part of the saliency evaluation, be used to determine one or more selected from: an intent, an expectation, a task or a goal of a device user in capturing the stored second image data; identification information or activity information of a device user capturing the stored second image data; identification information or activity information of a first social network user interacting with the stored second image data; identification information or activity information of a second social network user associated with the first user in the social network. The determination may influence the identification of the one or more features, regions or objects of interest as part of the saliency evaluation. The determination may be supported by a feature recognition or object recognition process as part of the saliency evaluation. The object may be segmented from the stored second image data based on the identification, using any suitable segmentation process. More accurate saliency evaluation may help to reduce the amount of unnecessary data included in downstream processing for rendering the display image.

In some examples, one or more environmental context values may be determined from the first image data, wherein the object is modified based on the one or more environmental context values. The environment of the first time period may have changed since the second image data was captured during the earlier second time period. For example the environment at the first time period may be subject to different weather or different lighting conditions, such as at a different time of day, different cloud cover, the presence of a different arrangement of light sources or light occlusions, or a different season. In such examples, the object may be modified in order to improve congruency of the object with the environmental context of the environment at the first time period. It will be understood that modification of the object may comprise addition of features which, when rendered as part of the display image, modify a visual quality of one or more elements in the environment to represent the effects of the object on the elements, such as for example a reflection of the object on a reflective element in the environment, or a lighting effect to represent a shadow on the element caused by the object. The term “environmental context values” will be understood to refer to any value characterizing a context associated with the environment of the first image data. In some examples, the environmental context value may represent one or more selected from: light source location, position and orientation, which may include natural and/or artificial light sources; light direction; light color; shadows; ambient light; reflections and highlights; a time of day; a weather condition; surface properties. The display image may comprise the modified object.

In some examples, third image data may be generated comprising the first image data and the object of the stored second image data, wherein the third image data may be stored, for example for accessing at a later time period. In such examples, the object, which may be modified based on the first image data, may be combined with the captured first image data to provide the third image data in which the object is positioned within the updated environment as captured during the first time period. In some such examples a user is able to make the object, modified for displaying in the environment captured during the first time period, available for displaying in the environment at a later time by combining the object with the first image data to provide the third image data. The third image data may be stored for later accessing as the stored second image data in an implementation of the presently described systems and methods at a later time period. A user may, in such examples create iteratively modified and stored image data for later accessing and displaying at a later time period. For example, in a first instance of the system or method, a user positioned in an environment may be identified as the object of the stored second image data which may form part of the display image rendered in the environment and positioned next to the user at the first time period. Upon visiting the same environment at multiple successive instances subsequent to the first instance, the user may position previous versions of themself identified as an object of successively stored second image data, next to themselves in the environment at each successive first time period, thereby creating an iteratively modified and stored third image data.

In examples including the step of generating third image data comprising the first image data and the object, wherein the third image data may be stored, for example for accessing at a later time period, the example methods and systems may in some cases not render the display image to the user. The control circuitry may, in some such cases, omit the rendering step in favor of generating and storing the third image data. In such examples, the control circuitry may determine, based on available computational resources at the user device or at the server, or based on available bandwidth, that only one of the rendering the display image, or generating and storing the third image data, may be performed. The control circuitry may, following the determination, perform the rendering or the generating and storing, or both.

The accessing may follow a detecting of an interaction with a virtual object in the environment via the extended reality device.

In some examples according to the systems and methods described herein, first image data of an environment is received, the first image data captured during a first time period and comprising data characterizing the environment using one or more selected from: depth information; two-dimensional image data; or data characterizing the environment in three dimensions. For example, the first image data may be received at or via a server from a user device, or at a processor of a said user device. Stored second image data of the environment, captured during a second time period earlier than the first time period, may be accessed, the second image data comprising data characterizing the environment in three dimensions during the second time period. The stored second image data may, for example, be stored at, and/or accessed from, any suitable memory, such as for example server memory or local memory of a user device. The stored second image data may be of the same type or different to the first image data. The second image data may be modified using the first image data, for example to include an object from the first image data, and the modified second image data may be stored as third image data for later accessing and displaying at a user device (for example an extended reality device). The object of the first image data may be identified by any suitable technique such as those disclosed herein.

It will be appreciated that any process steps and functionality of the present disclosure, in any suitable combination thereof, may be performed on a user device or at a server. The performance of steps or functionality at a server may in some cases act to conserve memory and computational processing resources on a user device.

It will be appreciated that any features described herein as being suitable for incorporation into one or more examples of the present disclosure are intended to be generalizable across any and all examples of the present disclosure.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 illustrates an overview of a system for asynchronous experience sharing between device users, for example users of an extended reality device, within a common environment, in accordance with some examples of the disclosure;

FIG. 2 is a flowchart representing a process for asynchronous experience sharing between device users, for example users of an extended reality device, within a common environment, in accordance with some examples of the disclosure;

FIG. 3 depicts a field of view of an image capture device of a user device of a first user visiting an environment at a first time, in accordance with some examples of the present disclosure;

FIG. 4 depicts a field of view of an image capture device of a user device of a second user present in the environment of FIG. 3 at a second time, earlier than the first time, in accordance with some examples of the present disclosure;

FIG. 5 depicts the field of view shown in FIG. 3 modified to include an object from the field of view depicted in FIG. 4 for display to the first user at the first time, in accordance with some examples of the present disclosure;

FIG. 6 is a flowchart representing a further process for asynchronous experience sharing between device users, for example users of an extended reality device, within a common environment, in accordance with some examples of the disclosure; and

FIG. 7 is a block diagram showing components of an example system for sharing an experience between users, in accordance with some examples of the disclosure.

### DETAILED DESCRIPTION

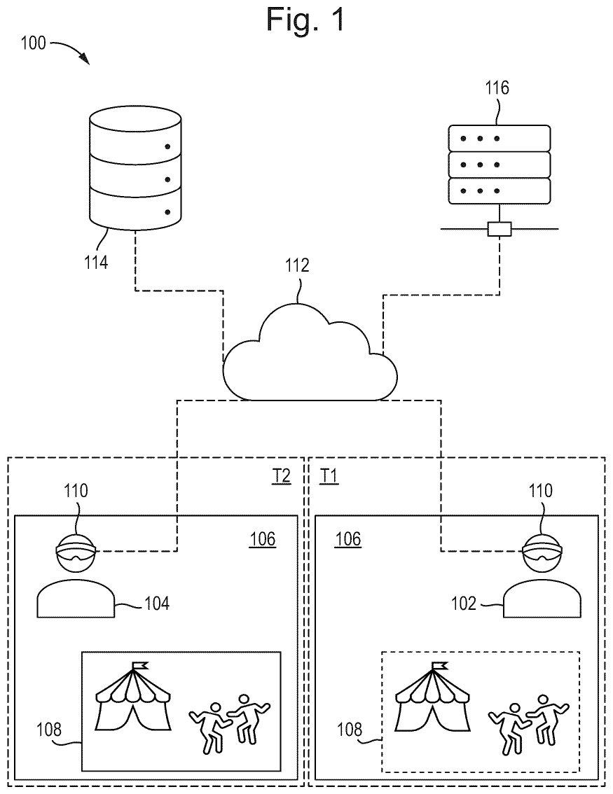

FIG. 1 illustrates an overview of a system 100 for asynchronous experience sharing between device users, for example users of an extended reality device, within a common environment. A first user 102 may visit a location at a first time T1 and a second user 104 may have already visited the location at a second time T2, earlier than the first time T1. The first time T1 may be any time after the second time T2, and may for example be at a later time during the same day, or may be separated from the second time T2 by days, months, weeks or even years. As such, if the second user 104 witnesses an event or occurrence taking place at the location during the second time T2, when the first user 102 arrives at the location during the first time T1, the event or occurrence may have long-since ended. Irrespective of the timing of each of the first and second users 102, 104 arriving at the location, the systems and method provided herein permit users to share in the experience of witnessing an event or occurrence at the location.

The example shown in FIG. 1 shows the first and second users 102, 104 positioned within the same environment 106 at the location, wherein the first user 102 is positioned within the environment 106 at the first time T1, and the second user 104 is positioned within the environment 106 at the earlier second time T2. The first and second users 102, 104 are depicted in different positions in the environment 106, but it will be appreciated that the first and second users 102, 104 may be at any position in the environment 106 at the respective first and second times T1, T2.

The system 100 comprises multiple user devices 110, each carried by a respective user of the first and second users 102, 104. Each user device 110 is configured to capture image data characterising the environment 106 in three-dimensions. For example the user devices 110 may comprise a camera and a depth sensor, or a camera having depth-sensing functionality. In the example shown, the respective user devices 110 are extended reality devices comprising a head-mounted display (HMD). In the specific example shown, the extended reality devices 110 are augmented reality-enabled devices, each comprising an outwardly oriented camera and depth sensor configured to capture three-dimensional video, such as spatial video, including point cloud data, from the environment 106. The extended reality devices 110 in the example shown further comprise a transparent display panel through which the respective user 102, 104 may view the environment 106, and on which a virtual display image may be rendered for viewing by the user in the environment 106. It will be appreciated that the user device 110 may be any suitable device, such as any augmented reality-enabled device, any virtual reality-enabled device, any mixed reality-enabled device, any spatial computing-enabled device, a smartphone, a tablet computer, or the like, the device configured to display or otherwise provide visual content to one or more respective users. In some examples, the system may comprise one or more separate imaging devices communicatively coupled to a user device 110. For example, a user may operate a camera, such as a headcam, to capture one or more images and/or videos. In the specific example shown, each user device 110 is configured to capture three-dimensional video data, such as spatial video, comprising point cloud data. It will be appreciated that any suitable data may be captured by the user device 110 which characterizes the environment in three-dimensions as discussed herein.

With the ever-improving capabilities of the Internet, mobile computing, and high-speed wireless networks, users are accessing media on user equipment devices on which they traditionally did not. As referred to herein, the phrases “user device”, “user equipment device”, “user equipment”, “user device”, “computing device”, “electronic device,” “electronic equipment”, “media equipment device”, or “media device” should be understood to mean any device for displaying and or capturing image data, as described above. In some examples, the user device may have a front-facing screen and a rear-facing screen, multiple front screens, or multiple angled screens. In some examples, the user device may have a front-facing camera and/or a rear-facing camera.

The system 100 may also include network functionality 112 such as the Internet, configured to communicatively couple user devices 110 to one or more servers 114 and/or one or more content databases 116 from which media content, such as images and videos, may be uploaded for storage by, and/or accessed for display on, the user devices 110. The user devices 110 and the one or more servers 104 may be communicatively coupled to one another by way of the network 112, and the one or more servers 114 may be communicatively coupled to the content database 116 by way of one or more communication paths, such as a proprietary communication path and/or the network 112. In some examples, the one or more servers 114 may be a server of a service provider which provides media content for display on user devices 110.

In the example shown, the second user 104 witnesses an event 108 occurring within the environment 106 at the earlier second time T2. The extended reality device 110 of the second user 104 captures image data characterising the environment 106, which includes the event 108, in three dimensions at the second time T2. The second user 104 uses the extended reality device 110 to upload and store the image data to the content database 116 by way of the remote server 114 using the network 112. The first user 102 visits the same environment 106 at the first time T1 wearing their respective extended reality device 110 configured to capture live image data characterising the environment 106 in three-dimensions at the first time T1. When the first user 102 arrives at the environment 106 at the later first time T1, however, the event 108 is no longer occurring. The first user 102 elects to access from the content database 116, using their extended reality device 110, the image data captured and stored by the second user 104 at the second time T2. Using the live captured image data at the first time T1, the extended reality device 110 may identify the event 108 from the stored image data, and display the event 108 as a display image for viewing in the environment 106. The first user 102 may be positioned such that the first image data is capturing the event 108 from a respective position in the environment 106 which is different from the position from which the stored image data was captured at the earlier second time T2. The characterizing of the environment 106 in three-dimensions of the stored image data and the live captured image data may enable the extended reality device 110 of the first user 102 to accurately display the event 108 for viewing from the different position of the first user 102.

It may be appreciated that in some situations the environment 106 at the first time T1 has changed since the earlier second time T2. For example, the first time Tl may be during a different time of day or in a different season that the second time T2. As such a direct re-rendering of the event 108 in the environment 106 for viewing by the first user 102 at the first time T1 may result in the re-rendered event 108 appearing incongruous with the environment 106 at the first time T1. In some examples therefore, the user device 110 of the first user 102 may be configured to modify the event 108, using the live captured image data characterising the environment 106 in three-dimensions at the first time T1, such that the rendered event 108 appears congruous with the environment 106 at the first time T1.

In some examples, a media platform may offer the opportunity for users to share three-dimensional videos, such as spatial videos with other users. A user device capable of capturing a three-dimensional video may add location metadata to three-dimensional video that may be used by media platform to position the three-dimensional video in a geographic location database. The user device may add additional metadata upon capture of the three-dimensional video, such as an orientation of the capturing device. The media platform may use metadata information to enrich the location database.

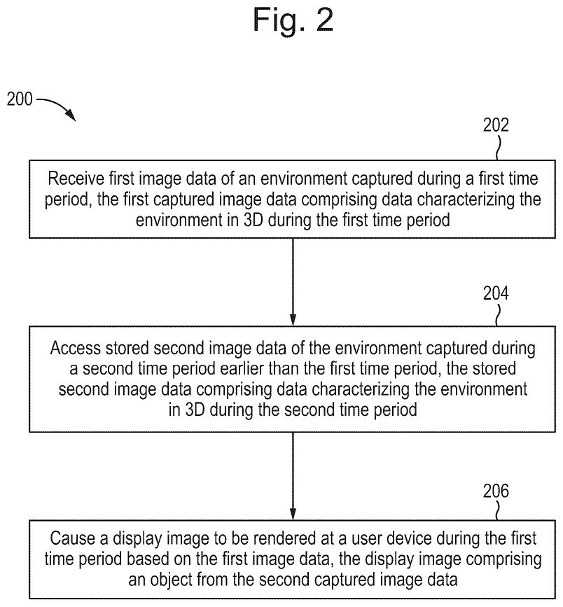

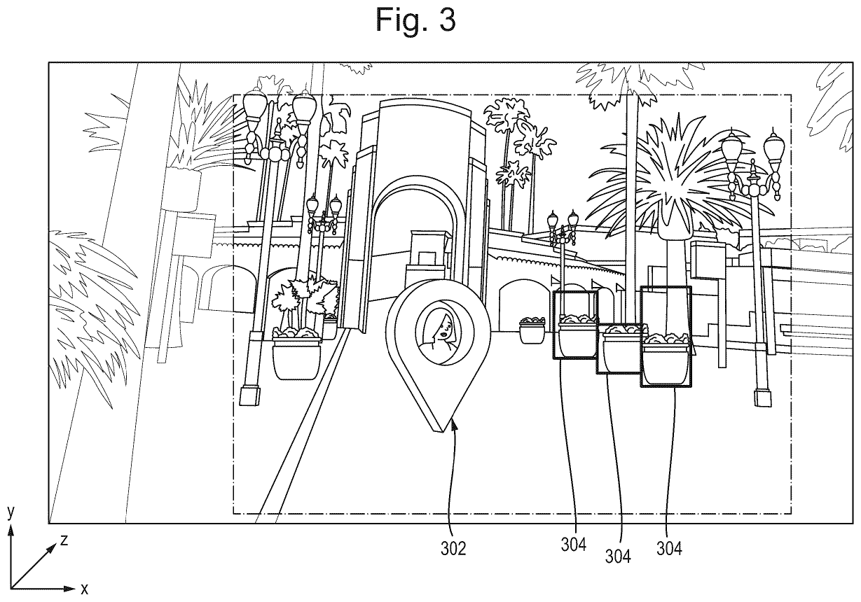

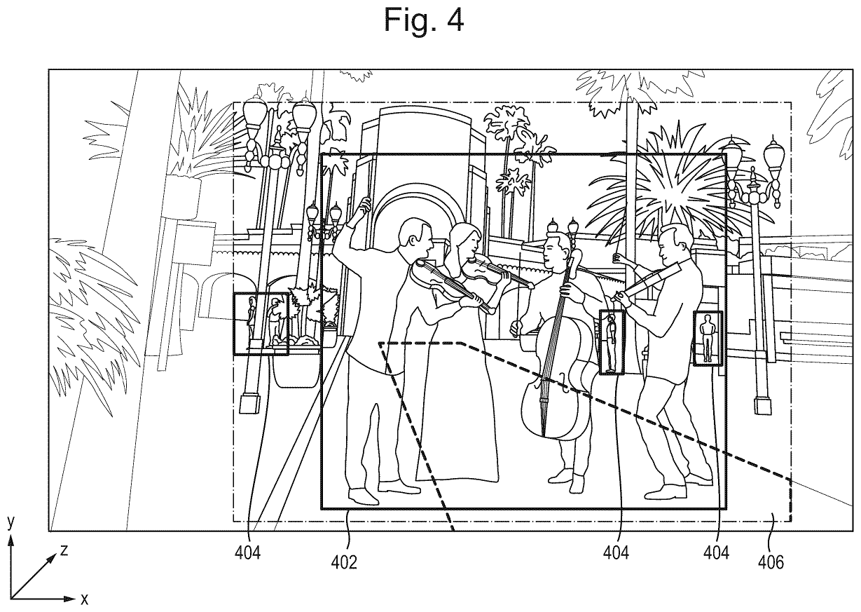

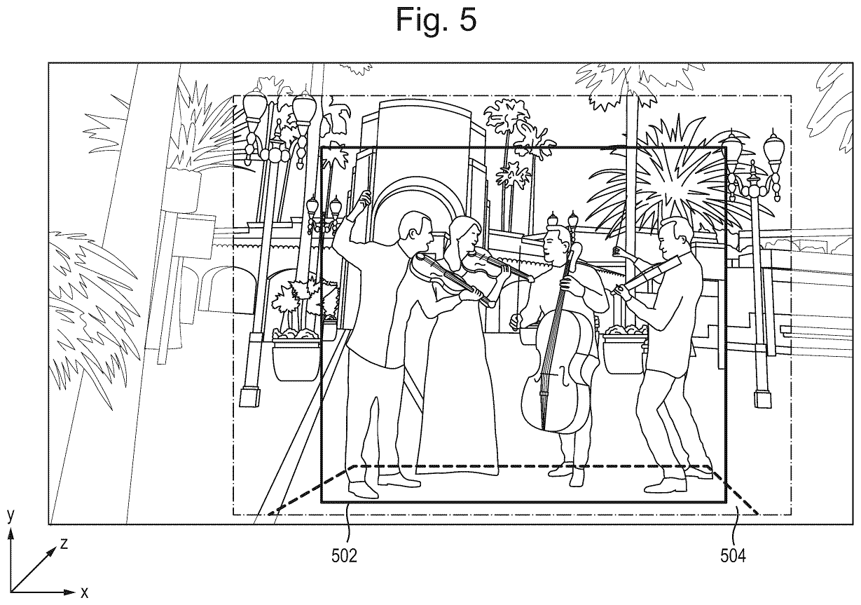

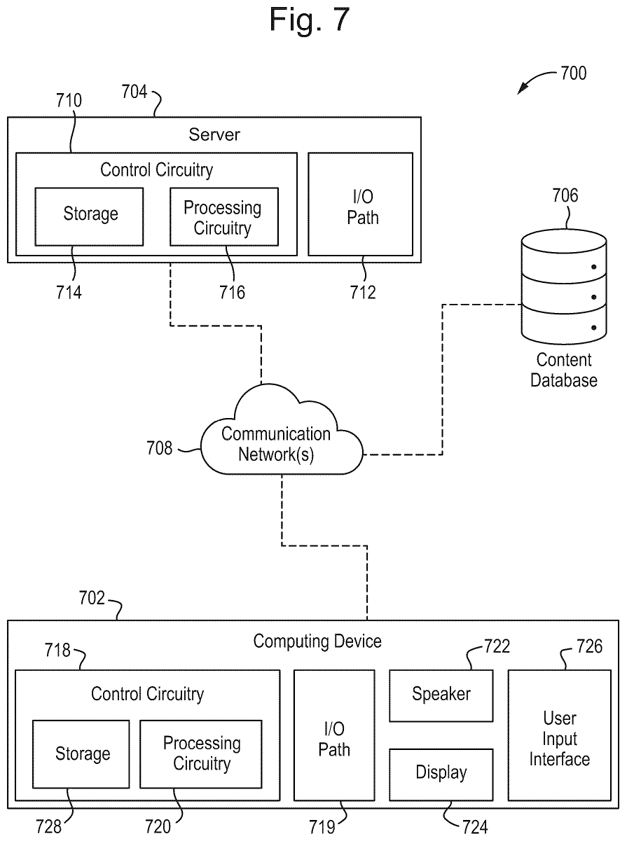

FIG. 2 shows a flowchart representing an illustrative process 200 for asynchronous experience sharing between device users, for example first and second users 102, 104 of an extended reality device 110, within a common environment 106, such as using a system 100 as represented in FIG. 1. FIG. 3 depicts an example field of view of a user device 110 of a first user 102 visiting an environment 106 at a first time T1, wherein the field of view includes an indication that an event 108 took place in the environment 106 at a second time T2 earlier than the first time T1. FIG. 4 depicts an example field of view of a user device 110 of a second user 104 visiting the environment 106 depicted in FIG. 3 at the earlier second time T2 during which the event took place. FIG. 5 depicts a field of view of the user device 110 of the first user 102 at the first time T1, wherein the event 108 which was occurring at the earlier second time T2 is rendered for viewing by the first user 102 at the first time T1, thereby permitting asynchronous experience sharing between the first user 102 and the second user 104. While the example process shown in FIG. 2 refers to the use of a system 100 as shown in FIG. 1, for example in the manner described below in relation to FIG. 3 to FIG. 5, it will be appreciated that the illustrative process 200 shown in FIG. 2 may be implemented, in whole or in part, on system 100 and/or any other appropriately configured system architecture, such as system 700 as represented in FIG. 7 and discussed herein. For the avoidance of doubt, the term “control circuitry” used in the below description applies broadly to the control circuitry outlined below with reference to FIG. 7. For example, control circuitry may comprise control circuitry of a user device 110 or control circuitry of a server 114, working either alone or in some combination.

At 202, control circuitry, e.g., control circuitry of a user device 110 or control circuitry of a server 114, receives first image data of an environment 106 during a first time period T1, the first image data comprising data characterizing the environment 106 in three-dimensions (3D) during the first time period T1. The first image data may be any suitable data characterizing the environment 106 in three-dimensions, and in the specific example shown is three-dimensional video data, such as spatial video, comprising point cloud data of the environment. The first image data captured during the first time period Tl may be of the full field of view of an image capture system of the first user device 110, or in some examples such as that depicted in FIG. 3, the first image data may be of a portion of the field of view of the image capture system of the first user device 110.

There may, such as in the example depicted in FIG. 3, be rendered on a first user device 110 for viewing in the environment 106 by a first user 102, an indication 302 that an event took place in the environment 106 at an earlier time. In the specific example shown, the indication 302 is a virtual indication rendered on a display of the first user device 110 for viewing in the environment at the first time T1, the virtual indication 302 configured for engagement by the first user 102. The engagement may, for example be by way of selecting the virtual indication 302, or by moving to be co-located with, proximate to, or within a threshold distance or viewing distance from, the virtual indication 302 in the environment. Such a virtual indication may indicate to device users such as the first user 102 that an earlier event was captured at that location by another user, for example available for playback by way of a content database of a media platform. The virtual indication may be positioned as a “social marker” for display to the first user within a field of view of the first user, for example upon detection that the first user is in the environment and/or within a viewing distance of the position at which an event was captured, or that a location in a location database corresponds to image data captured, stored and/or shared by another user. The rendering of the virtual indication may be based on the first image data, for example wherein an accurate position of the virtual indication is determined for rendering to the first user in a realistic manner based on the first image data which characterizes the environment in three-dimensions.

Such virtual indications, such as social markers, may in some examples only be rendered for viewing by the first user when the first user activates a social media application on their user device, which may be any suitable video playback device, such as a three-dimensional video or spatial video playback device. In some examples, the user device may be configured (for example by the social media application) such that the first user may choose which areas will not show any said virtual indications or social markers. By way of example, if the first user is visiting a very popular area, the first user may decide to “mute” virtual indications or social markers for the area, or the first user may decide to, by way of the user device, only render virtual indications or social markers associated with a predetermined list of users, for example users at a threshold distance from the first user in a social network, for example users that the first user knows or whom the first user follows by way of the social media application. Virtual indications or social markers may, in some examples, be automatically prioritized for display to the first user based on a proximity of the first user in a social network to other users of the social network, or based on any other suitable parameters for recommending content to the first user, such as based on popularity or frequency of, and type of, interaction with the virtual indications or social markers.

At 204, control circuitry, e.g., control circuitry of a user device 110 or control circuitry of a server 114, accesses, e.g., from a content database 116 by way of a server 114 accessible on a network 112, stored second image data of the environment 106 captured during a second time period T2 earlier than the first time period T1, the stored second image data comprising data characterizing the environment in 3D during the second time period T2. The second image data may be any suitable data characterizing the environment 106 in three-dimensions, and in the specific example described is three-dimensional video data, such as spatial video, comprising point cloud data of the environment 106. With reference to the specific example of FIG. 3, the stored second image data may be associated with the virtual indication 302, wherein the engagement therewith causes the accessing by the control circuitry. In other examples the accessing may be caused by determining (e.g., by control circuitry) a co-location of, or a proximity of, the first user device with a location associated with the stored second image data. Examples will be appreciated wherein the stored second image data may be accessed following selection of the stored second image data, or content associated therewith, by the first user, for example from a menu or by way of a social media post. Any suitable mode of triggering the accessing of the stored second image data by the control circuitry will be envisaged.

The stored second image data may characterize the environment in three-dimensions in accordance with the field of view of an image capture system of a second user device 110 of a second user 104 positioned within the environment 106 at the second time period T2. An example field of view is depicted in FIG. 4. During the second time period T2, the second user 104 may for example witness an unexpected or impromptu event or occurrence taking place within the environment during the second time period T2. With reference to the specific example depicted in FIG. 4, the environment 106 may be an area within a popular amusement park, wherein the unexpected or impromptu event may be a string quartet performance 402.

At 206, control circuitry, e.g., control circuitry of a user device 110 or control circuitry of a server 114, causes a display image to be rendered at a user device during the first time period based on the first image data, the display image comprising an object from the second image data. With reference to the specific example depicted in FIG. 5, following interaction of the first user 102 with the virtual indication 302 or social marker, the display image is rendered at the first user device 110 for viewing in the environment 106 by the first user 102 during the first time period T1. In the example of FIG. 5, the object 502 is the string quartet performance 402 of the stored second image data depicted in FIG. 4, which is triggered for playback to the first user 102 at the first time T1. In the example depicted, a position of the string quartet performance 402 in the environment 106 is determined from the second image data which characterizes the environment 106 in three-dimensions. A corresponding position of the object 502 is determined using the live captured first image data, for rendering the object 502 at the correct position in the environment 106 for viewing by the first user 102 during the first time period T1.

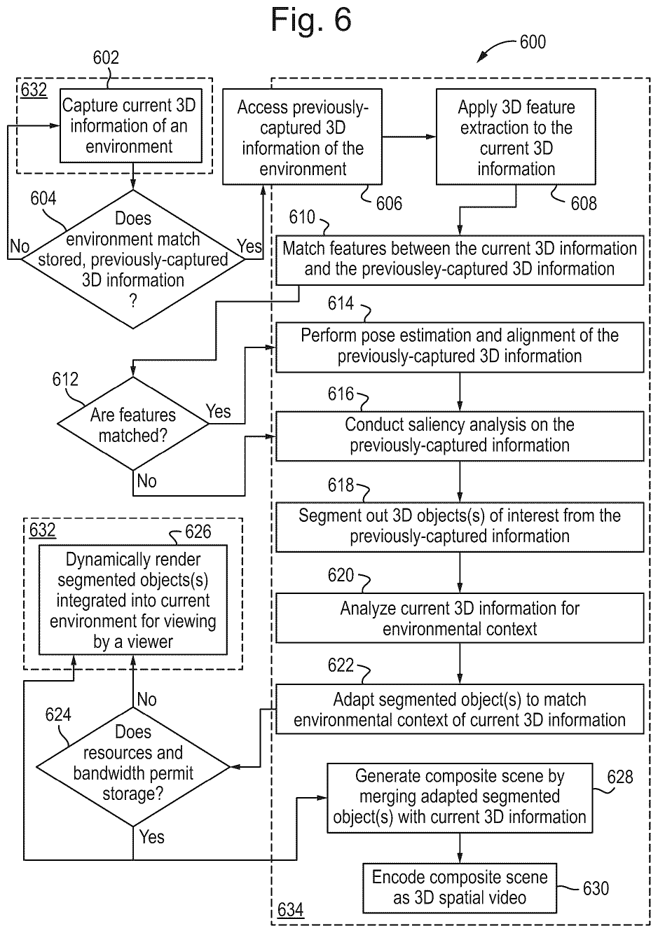

FIG. 6 depicts a flow chart indicating a further example process 600 comprising additional steps in providing the experience sharing depicted in FIG. 3 to FIG. 6, in addition to the steps shown in FIG. 2. Steps of the process as depicted in FIG. 6 may be performed either device-side 632 or server-side 634, or in some cases may comprise sub-steps which are performed either device-side and server-side. While the example shown in FIG. 6 depicts various steps in the process being performed either device-side 632 or server-side 634, where suitable it will be appreciated that any of these steps may be performed either device-side 632 or server-side 634. Performance of data processing steps server-side 634 may act to conserve memory and computational resources on a user device.

In the example further process steps of FIG. 6, during the live capture of the first image data 602, the control circuitry may in some examples determine whether the environment of the live capture matches the environment of previously-stored second image data 604. The determination may be performed in any suitable manner, and may for example comprise the comparing of a current location, for example of a device used to capture the first image data, with location information of stored previously-captured second image data. The control circuitry may in some examples access a location database of a media platform and determine whether stored previously-captured second image data is present and associated with the same location as a location of the user device. If the environment matches an environment of stored, previously-captured second image data, the stored, previously-captured second image data may be accessed. In some examples, there may be multiple stored, previously captured second image data having the same environment as the live-captured first image data. This may be the case for popular tourist attractions or environments in which a popular event occurred or simply environments which see regular foot traffic.

In such examples, the control circuitry may access the second image data of the plurality of second image data, in accordance with a score. The score may in some examples be a similarity score evaluating a similarity of the second image data to the live-captured first image data. The similarity score may in some examples evaluate a similarity of a perspective of the second image data to a perspective of the live-captured first image data. Increasing similarity in perspective across the first image data and the second image data may result in a reducing of computational processing required in the downstream processing steps of the method. Other examples will be appreciated wherein any suitable selection of the second image data from among a plurality of the second image data is performed by the control circuitry. In some examples, the user of a user device associated with the live captured first image data is provided with a user interface, such as a menu comprising the plurality of the second image data, receiving input from the user selecting of one of the plurality of second image data to be accessed by the control circuitry. The menu may, for example, rank the plurality of the second image data such as by relevance to the user, which may be driven by social network data of the user. The menu may rank the plurality of the second image data by any suitable metric such as by recency or by popularity.

After accessing of the earlier captured second image data 606, and prior to the rendering of the display image 624, the control circuitry may be configured to identify differences and similarities between the first image data and the accessed second image data. In the example depicted in FIG. 6, with reference to FIG. 3 to FIG. 5, the control circuitry may perform a feature extraction 608 on the first image data for comparison with corresponding features extracted from the second image data. In the particular example shown, 3D feature extraction algorithms are applied to point cloud data of the first image data, which is performed server-side 634, with extracted features being compared with features similarly extracted from, and stored alongside, the second image data during the second time period T2. Examples will be appreciated wherein feature extraction of the first and second image data may be performed either device-side or server-side. Example three-dimensional feature extraction techniques may include: Fast Point Feature Histogram (FPFH) generation, which captures the local geometric structure around points in point cloud data by computing histograms of surface normals in the neighborhood of the points; 3D Scale Invariant Feature Transform (SIFT) which is an adaptation of the Scale Invariant Feature Transform for 3D point cloud data, capturing invariant features across scales; PointNet and PointNet++, which is a deep learning approach which directly processes point cloud data, learning an optimal set of feature descriptors for classification and segmentation tasks. Any suitable feature extraction method may be envisaged.

The comparison of extracted features may comprise an identification of matched features across the first image data and the second image data and/or unmatched features which are present in the second image data but not present in the first image data and/or unmatched features which are present in the first image data but are not present in the second image data. For feature extraction, the control circuitry may use a matching algorithm to find correspondences between feature descriptors extracted from the first image data and from the second image data. This may involve nearest-neighbor searches, which may be accelerated using algorithms like KD-trees or approximated nearest neighbor techniques for efficiency. Robust feature matching techniques such as RANdom SAmple Consensus (RANSAC) may be implemented to filter out outliers and ensure that only reliable matches are used for pose estimation and scene alignment.

The matched features and the unmatched features may be determined by the control circuitry 610, with each feature determined to be matched or unmatched 612. The matched features in the example shown are used for corresponding pose estimation and scene alignment processes 614. The pose estimation and scene alignment processes 614 are intended to align the environment of the second image data with the environment of the live-captured first image data such that rendering of objects identified from the second image data for viewing at the first time T1 are subsequently correctly positioned relative to the environment at the first time Tl when the objects are rendered for viewing. The pose estimation and scene alignment processes may comprise any suitable pose estimation and scene alignment techniques as will be appreciated. In some examples, a pose estimation algorithm may be used by the control circuitry such as Iterative Closest Point (ICP) variant optimized for feature-based matching, to determine the relative pose between the first image data and the second image data. This may for example involve solving for translation and rotation that best align the matched features. Further refinement may be implemented to refine the alignment of the second image data with the first image data, using optimization techniques that reduce the error in the alignment of matched features, ensuring a precise overlay of the second image data onto the first image data.

In the example shown in FIG. 4, unmatched features are used as part of a saliency evaluation 616 to determine the string quartet performance 402 as a salient object within the second image data. As part of the determination, unmatched features identified from the second image data, including the string quartet performance 402, may be ranked in accordance with a saliency metric. Additional unmatched features may include passers-by 404 in the second image data, which may be determined by the saliency evaluation to be unrelated to the string quartet performance 402 in accordance with the ranking. In the example shown, during the earlier second time period T2, the string quartet performance 402 was part of a broader celebration event, wherein a red carpet 406 was also present in the environment 106. The red carpet 406 may be identified as part of the saliency evaluation as salient only in particular circumstances. Example saliency techniques may conduct saliency analysis on point cloud data of the second image data for unmatched regions, features or objects to identify features, regions or objects or elements of interest based on their visual and spatial uniqueness. With particular reference to the example shown in FIG. 3 to FIG. 5, the control circuitry may identify individual people in string quartet performance 402 but not the people walking in the background 404. The control circuitry may then prioritize these identified elements for further processing, based on their determined relevance or prominence within the second image data.

As part of the saliency evaluation 616 and/or any subsequent segmentation 618 of salient objects from the second image data (and/or the first image data), the control circuitry may use semantic segmentation 618 to identify one or more elements of the second image data, and may correlate these identified elements with additional metadata which may be input by the second user, such as a video caption when sharing the second image data on a social media platform. In the example of FIG. 4, the second user may have posted their video comprising the second image data on the media platform accompanied by the caption “We had our own private concert at Universal Studio today!,” and the control circuitry may accordingly associate the term “concert” in the caption, with the string quartet performance 402 in a semantically-segmented elements list, and determine that the string quartet performance 402 is the prominent part of the second image data that the user intends to be mixed into the first image data. It will be appreciated that in some examples the control circuitry may, following the sematic segmentation 618, further process the second image data and only store the portion of the second image data determined to be salient for rendering as part of an on-location playback to the first user at the first time. The storage may be in a specially-designated datastore location dedicated to such playback functionality. Upon detection that such a second image data is to be played on-location in conjunction with the first image data at the first time, the control circuitry may accordingly only download the portion of the second image data which was determined to be salient, and may therefore save memory usage, bandwidth and processing power at the user device of the first user.

Once identified as salient, the string quartet performance 402 may be segmented 618 out of the second image data for rendering as an object for viewing during the first time period T1. Such segmentation may be performed using any suitable segmentation techniques as will be appreciated. In the specific example described, the control circuitry may apply 3D point cloud segmentation techniques, which may include semantic segmentation using PointNet-based architectures, to isolate identified objects of interest from the rest of the second image data. The control circuitry may refine the segmentation to ensure clean extraction of objects, preparing them for rendering in the display image for viewing during the first time period. It will be appreciated that feature extraction and segmentation performed on the second image data may be performed by a user device of the second user or may be performed at a server during or following storing of the second image data, for example for access at the content database by way of the server performing feature extraction and/or segmentation, along with any other suitable steps of the presently disclosed process at a server and off-device can act to conserve computing resources and power supply on a user device, while making use of potentially more capable computer processing resources server-side.

In some examples, the control circuitry may use the first image data and the second image data to detect three-dimensional object (for example people) conflicts when the first user stands at a location in the environment. For example there may be foreground objects overlapping in three-dimensional space with the foreground string quartet performance 402 in the second image data. The control circuitry may accordingly remove the conflicting object (for example people) within a three-dimensional bounding box of the string quartet performance 402 and render the string quartet performance 402 visually correct without the conflicts. In some examples, the object may be modified to account for such conflicts (such as foreground people), wherein the conflicts may be wrapped, or the object cropped, such that when the object is rendered the conflicts appear in front of the string quartet performance 402 or alternatively behind it, with an empty space created in the environment of the first image data for the string quartet performance 402. Such functionality may be performed with real-time, dynamic, three-dimensional analysis and rendering.

Movement variations may be determined when evaluating which features or elements of the second image data significantly differ from the first image data. In the example depicted in FIG. 3 to FIG. 5, the palm trees captured in the second image data may be moving differently compared to the palm trees of the first image data. Rendering of the object may not include the palm trees from the second image data in place of, or mixed with, the palm trees of the first image data based on the movement.

The control circuitry may compare individual frames from the second image data and the first image data, which may include a frame per eye of an extended reality device, and detect translations, rotations or other non-linear deformations of features or elements in the first and second image data, and determine to render a frame of the second image data preferentially over a frame of the first image data. A similar comparison may be performed on the positional information of features or elements determined to be moving in the environment in the first and second image data, for example by comparing a subset of a point cloud referring to one feature or element in the second image data with the same feature or element in the first image data, and if the difference exceeds a predetermined threshold indicative of a significantly different object in the second image data, the control circuitry may determine to render the element or feature of the second image data instead of the element or feature of the first image data.

Unmatched features may also be identified and/or segmented in the first image data, for example the newly-positioned plant pots 304. Such identifications may be used during the pose estimation and scene alignment processes 614. The identifications may be used when rendering 626 the object 502, which may include a determination of whether the unmatched plant pots 304 impact the positioning or visual parameters of the object 502, for example an opacity or transparency of portions of the object 502 to correctly position the object 502 in the environment 106 relative to the unmatched features.

It will be appreciated that the environment 106 may have changed between the second time period T2 and the first time period T1. A direct re-rendering of the segmented string quartet performance 402 from the second image data in the environment during the first time period T1 may result in the string quartet performance 402 appearing incongruous with the environment 106 of the first time period T1. It may therefore be required to consider the updated environmental context of the environment 106 during the first time period Tl such that the environmental context may drive one or more modifications to the segmented string quartet performance 402 prior to rendering. As such, the live-captured first image data may be analyzed to obtain one or more environmental context values 620. For example, the control circuitry may analyze the live-captured first image data for environmental context (such as lighting, scale, and spatial layout) and may accordingly adapt a segmented object or objects to match the environmental context or conditions of the first image data, adjusting object scale, orientation, texture, and lighting to ensure a natural fit with the environment during the first time period.

The environmental context values may in some examples characterize an ambient light in the environment. The overall lighting of the environment may affect how all objects in the environment are illuminated and may therefore changes in ambient light may be represented in the environmental context values, thereby permitting modification of the object to simulate, for example, different times of day or weather conditions. The environmental context values may in some examples characterize a light intensity in the environment, which may be linked to the strength or intensity of light sources, such as natural or artificial light sources in the image. Different times of day and weather conditions may have varying light intensities, from the bright midday sun to the soft glow of dawn or dusk, or the diffused light on an overcast day. The environmental context values may in some examples characterize a light direction of one or more light sources indicating for example in which direction light is coming relative to the object. This may influence shadows and highlights on the object, which may be adjusted to match the position of a light source in the environment. The environmental context values may in some examples characterize a color temperature, which may be linked to the color of the light, which may change in accordance with a time of the day of the first time period (for example warmer at sunrise and sunset, and cooler at noon), and may further change in accordance with weather (for example cooler under overcast skies).

The environmental context values may in some examples characterize shadows, which may include the presence, direction, length, and softness of shadows cast by the object. The shadows may for example change with the position of a light source in the environment and may be linked to a time of day of the first time period. For example, shadows may be longer at sunrise or sunset and shorter at noon. The environmental context values may in some examples characterize highlights and reflections, such as bright spots on the object that may reflect a main light source in the environment. These may need to be adjusted according to a new light intensity and direction in the environment at the first time period.

The environmental context values may in some examples characterize an atmospheric perspective, such as the effect of the atmosphere on the object based on a position or orientation of the object and the depth of the position in the environment relative to the user device or the viewer. For example, the object may be modified to appear more faded or bluish based on the presence of atmospheric effects, particularly during specific weather conditions like fog or mist. The environmental context values may in some examples characterize a sky appearance, wherein the appearance of the sky at the first time period may influence the mood and lighting of the environment and therefore the object. Changing from a clear sky during the second time period to a cloudy sky during the first time period, or vice versa, may for example require modification of the overall color and light diffusion of the object in the environment.

The environmental context values may in some examples characterize weather effects, such as to modify the object to represent weather conditions, such as raindrops, snow, or fog, that may need to be added or modified on the object. These effects may also influence visibility and color saturation of the object. The environmental context values may in some examples characterize wet surfaces or a surface wetness, representing the presence of wet surfaces in the environment for modification of the object surfaces accordingly, for example to indicate recent rain. Reflectivity, both of the object and of wet surfaces in the environment (for example puddles) may be considered when modifying the object, or indeed other portions of the first image data, for wet weather conditions.

The environmental context values may in some examples characterize movement of natural or inanimate elements within the environment or of the object, such as hair, fabric, vegetation or water, for example in windy conditions. The appearance of hair, vegetation, water, and other inanimate elements may change with the seasons, time of day, and weather conditions which may require modification of the object. The environmental context values may in some examples characterize visibility and contrast. Overall visibility and contrast in the environment can be affected by weather conditions. For example, fog, rain, or mist reduces visibility and contrast, whereas clear weather conditions have higher visibility and contrast.

In some examples, the environment context values may indicate that a level of change in the environmental conditions between the first time period and the second time period represent too great a change, for example based on available computational resources or bandwidth. In some such examples the processing requirements for modifying the object in accordance with the environment context values may exceed a threshold. In such examples the control circuitry may, in response to determining that the processing requirements exceed the threshold or the available computational resources or bandwidth, issue a notification that the processing requirements exceed the threshold, the available computational resources or the bandwidth. In other examples, in response to determining that the processing requirements exceed the threshold or the available computational resources or bandwidth, the control circuitry may cause the second image data to be rendered at the user device. The rendered second image data may replace a render of the current environment, or may be rendered as a display image overlaying or occluding a view of the current environment.

Upon determining the one or more environment context values 620 the string quartet performance 402 may then be modified based on the one or more environmental context values 622. In the specific example of FIG. 5, the object 502 is modified based on the first image data to include shadow data 504 which, when rendered 626 as part of the display image for viewing in the environment 106 at the first time T1, causes the object 502 (the string quartet performance in the example shown) to appear congruous with the environment 106 at the first time period T1. In particular, the shadow data 504 represents accurate shadow positioning based on the direction of light sources in the environment 106 during the first time period. In some examples the control circuitry may dynamically render and integrate the prepared objects into the display image for viewing, for example during dynamic environmental (such as lighting) conditions which may be provided by moving cloud cover. The control circuitry may use extended reality techniques, such as augmented reality techniques, to place the object or objects accurately within the environment for viewing by a user, ensuring realistic interactions like proper occlusion and shadowing. The control circuitry may additionally monitor movement of the user in the environment, along with corresponding viewpoint and perspective changes, updating the display image in real-time to maintain spatial consistency.

The modified object may additionally, or alternatively, be combined with the first image data to form a composite third image data 628 wherein the object is depicted in the environment 106 of the first time period T1. As such the control circuitry may construct a composite scene that merges the live captured first image data with the inserted objects, maintaining a coherent 3D spatial appearance. The control circuitry may encode this composite scene into a new 3D spatial video format, preserving high-quality visual and depth information for playback on compatible devices. The composite third image data may then be stored 630 for accessing at a later time period, whether for viewing an object therein within the environment at a later time period, or for creating further composite image data. The composite image generation and storage may depend on the availability of sufficient bandwidth or computational resources, such as memory or processing capacity, for example at a user device 624.

In some examples, control circuitry, for example by way of a social media system, may send a notification to the second user that their stored video was played by the first user. In an example wherein the first user generates third image data formed of a composite video of the first image data and the object determined from the second image data, the control circuitry may transmit an alert to a user device of the second user, for example indicating that the third image data is available. The control circuitry may permit access of the user device of the second user to the third image data. The control circuitry may, for example in response to an input or request received at the second user device from the second user, transmit a copy of the third image data to the user device of the second user. The third image data represents a new and updated version of the second user's own video, potentially within an updated environment, with updated backgrounds, and potentially new activity alongside the original foreground. For example, the first user may have captured a person standing in front of the string quartet performance and singing a song. The second user may be informed of the existence of the third image data by way of the alert, may be provided access to the third image data, and may in some examples be provided with a copy of the third image data, for example following a request or confirmation received at the user device of the second user.

In some examples, the storing of the composite third image data for accessing as stored second image data within systems and methods of the present disclosure may provide a more up-to-date reference point of the environment and the object, for when the third image data is accessed as stored second image data. This may in some examples reduce the computational resources required in modifying the object for viewing in the updated environment. For example, a first user arrives in an environment in winter, and a plurality of stored second image data are available for viewing a past object or event in the environment, the object or event originally having been captured in the environment during summer. In accordance with systems and methods of the present disclosure, accessing the stored second image data may comprise selecting from the plurality of stored second image data depicting the object or event, the most recent stored second image data depicting the object or event. The selected most recent stored second image data depicting the object or event may be a said third image data, in which the earlier object or event was updated for viewing in the environment in similar environmental conditions, which in this example are winter conditions. Modifying the object or event for rendering in the display image may therefore require reduced processing resources, or in some cases may not require modification.

In some examples, a location database linking locations or environments with corresponding stored image data may include information such as a time the image data was captured, a camera orientation, a weather condition, a color grading, or any suitable metadata associated with the image data. The control circuitry may use the information associated with the image data to determine or modify how the stored image data is rendered into a live-viewed environment based on the live-captured image data. In the examples described herein, the control circuitry may detect that the second image data was captured at noon on a clear day, with the sun behind the second user's back, whereas the live-captured first image data may be captured at the end of the day with the sun facing the first user. The control circuitry may therefore use this information when determining how to modify the object for rendering to the first user, for example to re-cast the shadows, and to adjust the impacts of lighting on elements it determines to mix into the live-viewed environment to improve a level of immersion of the first user and a spatial quality of the render. In further examples, wherein each stored second image data is associated with a corresponding time stamp, a sequential or historical layering of image data may be performed so that users can watch how the environment changes over time, which occur over any suitable length of time including years or hours. Such examples may find particular use for tourism, wherein tourists may be presented with a visual historical archive of a region or a place, or for example a four-seasonal transition of a region or a place, through combined three-dimensional or spatial videos.

In further examples, a media platform may permit sharing of composite or remixed spatial videos, for example including the combined third image data of the examples described herein, comprising a combination of the second image data and the first image data. A second user may share second image data comprising a second video at a location. A first user may visit that location and playback the second video generated using the methods described herein, thus generating a composite third image data including a third video depicting a combination of the second video and live-captured first image data. The third video is a remix of the second video. The control circuitry may permit the first user to record that third video and share it on the media platform. In an example the first user visits the location and asks someone there to take the third video of that first user at that location. On another occasion, a second user may visit the same location with that first user and remix a fourth video that may include the first user in the third video and the first user in the live-captured image data, allowing some creative video compositing. More remixes can be produced over the course of several subsequent visits to the same environment and more copies of the first user may be rendered in each subsequent video of the remixed videos.

FIG. 7 is an illustrative block diagram showing example system 700 configured to display media content. Although FIG. 2 shows system 700 as including a number and configuration of individual components, in some examples, any number of the components of system 700 may be combined and/or integrated as one device, e.g., as user device 110. System 700 includes computing device 702, server 704 (e.g., server 114), and content database 706 (e.g., content database 116), each of which is communicatively coupled to communication network 708 (e.g., network 112), which may be the Internet or any other suitable network or group of networks. In some examples, system 700 excludes server 704, and functionality that would otherwise be implemented by server 704 is instead implemented by other components of system 700, such as computing device 702. In still other examples, server 704 works in conjunction with computing device 702 to implement certain functionality described herein in a distributed or cooperative manner.

Server 704 includes control circuitry 710 and input/output (hereinafter “I/O”) path 712, and control circuitry 710 includes storage 714 and processing circuitry 716, which may comprise imaging processing circuitry. Computing device 702, which may be an extended reality device for example comprising a HMD, a personal computer, a laptop computer, a tablet computer, a smartphone, a smart television, a smart speaker, or any other type of computing device, includes control circuitry 718, I/O path 719, speaker 722, display 724, and user input interface 726. Control circuitry 718 includes storage 728 and processing circuitry 720. Control circuitry 710 and/or 718 may be based on any suitable processing circuitry such as processing circuitry 716 and/or 720. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores). In some examples, processing circuitry may be distributed across multiple separate processors, for example, multiple of the same type of processors (e.g., two Intel Core i9 processors) or multiple different processors (e.g., an Intel Core i7 processor and an Intel Core i9 processor).

Each of storage 714, storage 728, and/or storages of other components of system 700 (e.g., storages of content database 706, and/or the like) may be an electronic storage device. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 2D disc recorders, digital video recorders (DVRs, sometimes called personal video recorders, or PVRs), solid-state devices, quantum storage devices, gaming consoles, gaming media, or any other suitable fixed or removable storage devices, and/or any combination of the same. Each of storage 714, storage 728, and/or storages of other components of system 700 may be used to store various types of content, metadata, and or other types of data. Non-volatile memory may also be used (e.g., to launch a boot-up routine and other instructions). Cloud-based storage may be used to supplement storages 714, 728 or instead of storages 714, 728. In some examples, control circuitry 710 and/or 718 executes instructions for an application stored in memory (e.g., storage 714 and/or 728). Specifically, control circuitry 714 and/or 728 may be instructed by the application to perform the functions discussed herein. In some implementations, any action performed by control circuitry 714 and/or 728 may be based on instructions received from the application. For example, the application may be implemented as software or a set of executable instructions that may be stored in storage 714 and/or 728 and executed by control circuitry 714 and/or 728. In some examples, the application may be a client/server application where only a client application resides on computing device 702, and a server application resides on server 704.

The application may be implemented using any suitable architecture. For example, it may be a stand-alone application wholly implemented on computing device 702. In such an approach, instructions for the application are stored locally (e.g., in storage 728), and data for use by the application is downloaded on a periodic basis (e.g., from an out-of-band feed, from an Internet resource, or using another suitable approach). Control circuitry 718 may retrieve instructions for the application from storage 728 and process the instructions to perform the functionality described herein. Based on the processed instructions, control circuitry 718 may determine what action to perform when input is received from user input interface 726.

In client/server-based examples, control circuitry 718 may include communication circuitry suitable for communicating with an application server (e.g., server 704) or other networks or servers. The instructions for carrying out the functionality described herein may be stored on the application server. Communication circuitry may include a cable modem, an Ethernet card, or a wireless modem for communication with other equipment, or any other suitable communication circuitry. Such communication may involve the Internet or any other suitable communication networks or paths (e.g., communication network 708). In another example of a client/server-based application, control circuitry 718 runs a web browser that interprets web pages provided by a remote server (e.g., server 704). For example, the remote server may store the instructions for the application in a storage device. The remote server may process the stored instructions using circuitry (e.g., control circuitry 710) and/or generate displays. Computing device 702 may receive the displays generated by the remote server and may display the content of the displays locally via display 724. This way, the processing of the instructions is performed remotely (e.g., by server 704) while the resulting displays, such as the display windows described elsewhere herein, are provided locally on computing device 702. Computing device 702 may receive inputs from the user via input interface 726 and transmit those inputs to the remote server for processing and generating the corresponding displays.

A user may send instructions, e.g., to capture an image and/or video, to control circuitry 710 and/or 718 using user input interface 726. User input interface 726 may be any suitable user interface, such as a remote control, trackball, keypad, keyboard, touchscreen, touchpad, stylus input, joystick, voice recognition interface, gaming controller, or other user input interfaces. User input interface 726 may be integrated with or combined with display 724, which may be a monitor, a television, a liquid crystal display (LCD), an electronic ink display, or any other equipment suitable for displaying visual images.

Server 704 and computing device 702 may transmit and receive content and data via I/O path 712 and 719, respectively. For instance, I/O path 712 and/or I/O path 719 may include a communication port(s) configured to transmit and/or receive (for instance to and/or from content database 706), via communication network 708, content item identifiers, content metadata, natural language queries, and/or other data. Control circuitry 710, 718 may be used to send and receive commands, requests, and other suitable data using I/O paths 712, 719.

The processes described above are intended to be illustrative and not limiting. One skilled in the art would appreciate that the steps of the processes discussed herein may be omitted, modified, combined, and/or rearranged, and any additional steps may be performed without departing from the scope of the disclosure. More generally, the above disclosure is meant to be illustrative and not limiting. Only the claims that follow are meant to set bounds as to what the present invention includes. Furthermore, it should be noted that the features and limitations described in any one example may be applied to any other example herein, and flowcharts or examples relating to one example may be combined with any other example in a suitable manner, done in different orders, or done in parallel. In addition, the systems and methods described herein may be performed in real time. It should also be noted that the systems and/or methods described above may be applied to, or used in accordance with, other systems and/or methods.

Listing of claims:

1. A method comprising:
receiving, using control circuitry, first image data of an environment captured during a first time period, the first image data characterizing the environment in three dimensions during the first time period;
accessing, using control circuitry, stored second image data of the environment captured during a second time period earlier than the first time period, the second image data characterizing the environment in three dimensions during the second time period; and
causing, using control circuitry, a display image to be rendered at an extended reality device during the first time period, based on the first image data;
wherein the display image comprises an object from the second image data.

2. The method of claim 1, wherein the object is disposed at a position in the environment in the second image data, wherein the rendering comprises rendering the object at the position in the environment.

3. The method of claim 1, further comprising modifying the object based on the first image data.

4. The method of claim 1, wherein accessing the stored second image data comprises:
determining that the environment characterized by the first image data is the same as the environment characterized by the second image data.

5. The method of claim 1, further comprising:
extracting a first plurality of features from the first image data; and
comparing the first plurality of features with a second plurality of features extracted from the stored second image data to identify at least one selected feature from:
one or more matched features of the first image data and the stored second image data; or
one or more unmatched features of the stored second image data; or
one or more unmatched features of the first image data;
wherein the display image comprises the at least one selected feature.

6. The method of claim 5, further comprising:
comparing the first plurality of features with the second plurality of features to identify the one or more matched features of the first image data and the stored second image data; and
spatially aligning the stored second image data with the first image data using the one or more matched features.

7. The method of claim 5, further comprising:
identifying the object from the stored second image data based on a saliency evaluation; and at least one selected from:
wherein the object is segmented from the stored second image data; or
wherein the object is identified based on the one or more unmatched features.

8. The method of claim 1, further comprising:
determining one or more environmental context values from the first image data; and
modifying the object based on the one or more environmental context values;
wherein the display image comprises the modified object.

9. The method of claim 1, further comprising:
generating third image data comprising the first image data and the object; and
storing the third image data.

10. The method of claim 1, wherein the accessing is performed in response to detecting an interaction with a virtual object in the environment via the extended reality device.

11. A system comprising:
an imaging device comprising a display arranged to be viewed by a viewer, and control circuitry configured to:
capture first image data of an environment during a first time period, the first image data characterizing the environment in three dimensions during the first time period;
access stored second image data of the environment captured during a second time period earlier than the first time period, the second image data characterizing the environment in three dimensions during the second time period; and
render, based on the first image data, a display image on the display during the first time period;
wherein the display image comprises an object from the second image data.

12. The system of claim 11, wherein the object is disposed at a position in the environment in the second image data, wherein the control circuitry is configured to render the object at the position in the environment.

13. The system of claim 11, wherein the control circuitry is further configured to:
modify the object based on the first image data.

14. The system of claim 11, wherein the control circuitry is further configured to, as part of accessing the stored second image data:
determine that the environment characterized by the first image data is the same as the environment characterized by the second image data.

15. The system of claim 11, wherein the control circuitry is further configured to:
extract a first plurality of features from the first image data; and
compare the first plurality of features with a second plurality of features extracted from the stored second image data to identify at least one selected from:
one or more matched features of the first image data and the stored second image data; or
one or more unmatched features of the stored second image data; or
one or more unmatched features of the first image data;
wherein the rendering is based on one or more selected from: the identified one or more matched features; or the identified one or more unmatched features.

16. The system of claim 15, wherein the control circuitry is further configured to:
compare the first plurality of features with a second plurality of features extracted from the stored second image data to identify the one or more matched features of the first image data and the stored second image data; and
spatially align the stored second image data with the first image data using the one or more matched features.

17. The system of claim 15, wherein the control circuitry is further configured to:
identify the object from the stored second image data based on a saliency evaluation; and one or more selected from:
wherein the object is segmented from the stored second image data; or
wherein the object is identified based on the one or more unmatched features.

18. The system of claim 11, wherein the control circuitry is further configured to:
determine one or more environmental context values from the first image data; and
modify the object based on the one or more environmental context values;
wherein the display image comprises the modified object.

19. The system of claim 11, wherein the control circuitry is further configured to:
generate third image data comprising the first image data and the object; and
store the third image data.

20. The system of claim 11, wherein the imaging device is an extended reality device, and wherein the control circuitry is further configured to:
detect an interaction with a virtual object in the environment; and
based on the interaction, perform the accessing of the stored second image data.

21-50. (canceled)
